(19) United States
(12) Patent Application Publication
(10) Pub. No.: US 2003/0019364 A1
(43) Pub. Date: Jan. 30, 2003

(54) Method for packing wine or a similar beverage, products obtained using said method and device for carrying out the method

(76) Inventor: Pascal Carvin, Sollies Pont (FR)

Correspondence Address: DENNISON, SCHULTZ & DOUGHERTY, 1745 JEFFERSON DAVIS HIGHWAY, ARLINGTON, VA, 22202, US

(21) Appl. No.: 10/148,202

(22) PCT Filed: Dec. 6, 2000
(86) PCT No.: PCT/FR00/03416

(30) Foreign Application Priority Data
Dec. 9, 1999 (FR) 99/15593

(51) Int. Cl. A23L 1/00

(52) U.S. Cl. 99/275

(57) ABSTRACT

The present invention relates to a method of packaging wine or a similar beverage, to products obtained by the method, and to apparatus for implementing the method. The present invention provides a method of packaging wine or a similar beverage in a receptacle in the form of a drinking glass (9), in which method said receptacle is made of glass and said glass receptacle is closed by means of a disposable capsule (1) having very low overall permeability to oxygen after being closed onto said receptacle.

The present invention relates to a method of packaging wine or a similar beverage, to products obtained by the method, and to apparatus for implementing the method.

French patent No. 2 735 003 describes a container in the form of a drinking glass used as the material for packaging, transporting, and distributing a beverage such as wine.

That patent also describes a method of filling the container, whereby the container closure element is fitted with a device that enables air to be extracted during filling.

The present invention seeks to provide an improved method of filling and packaging a wine glass.

The object of the invention is specifically to lengthen the shelf life of wine packaged in a receptacle in the form of a drinking glass; wine can become transformed due to contact with air, in particular due to phenomena whereby the wine is oxidized, via its free surface which is of much larger area in a glass than in a bottle, particularly when it is recalled that the area should be compared with the volume of wine contained in the glass, or the bottle as the case may be.

The advantage of improving the above-mentioned patent can thus be seen, particularly when packaging wines for laying down or wines that are intended to be consumed more than one month, preferably more than four months, any indeed more than ten months after packaging.

In a first aspect, the present invention thus consists essentially in packaging wine or a similar beverage in a receptacle that is completely closed, whose overall permeability to oxygen, i.e. permeability including that of the walls of the receptacle, of the capsule, and of the junction zone between said receptacle and said capsule, makes it possible to conserve a wine in the long term, preferably more than ten months, without exceeding a tolerable quantity of oxygen. To do this, the walls of the receptacle are made of a material that is not permeable or practically not permeable to oxygen in the long term, and in particular said receptacle is made of glass. Glass presents practically zero permeability to oxygen.

If the capsule presents very low overall permeability after it has been closed onto said receptacle, and preferably permeability of not more than 10 cubic centimeters per square meter per 24-hour period (cm³/m²/24 h), then it is possible to conserve a wine for more than ten months.

In a first aspect, the invention thus consists in a method of packaging wine or a similar beverage in a receptacle in the form of a drinking glass, in which such a glass receptacle is closed by means of a disposable capsule (for single use, i.e. which can be removed but which cannot be put back into place), having very low overall permeability to oxygen once closed on said receptacle, and preferably permeability of less than 10 cm³/m²/24 h.

A laminated capsule is preferably used comprising a metal layer coated in a layer of heat-sealable thermoplastic material, presenting overall permeability to oxygen, after heat-sealing, of not more than 10 cm³/m²/24 h.

The oxygen content of the gaseous atmosphere imprisoned inside the glass is preferably reduced to a value below the mean oxygen content of air (i.e. about 20% by volume).

More preferably, the wine is packaged under a gaseous atmosphere whose oxygen content is less than or equal to 5% by volume and/or under a partial vacuum.

Advantageously, the glass is filled with wine under an inert atmosphere, comprising carbon dioxide.

By selecting a capsule whose overall permeability to oxygen after bonding onto said receptacle is less than 5 cm³/m²/24 h, and by packaging the wine under an inert atmosphere comprising carbon dioxide or a mixture of nitrogen and carbon dioxide, and even when the residual space defined by the glass, the free surface of the wine, and the capsule has a volume greater than 2 cm² (contrary to the above-mentioned patent), it has been found that wine packaged in this way can be conserved for very long periods (up to twenty-four months). Naturally, it is both possible and desirable to limit said residual space to a volume of said value.

Packaging in an atmosphere comprising carbon dioxide presents the additional advantage that the gas can become absorbed and dissolved in the wine over a period of several hours following packaging, thereby lowering the pressure inside the glass. Thus, if the receptacle of the invention should subsequently be exposed during storage to conditions in which ambient temperature is raised, and in particular raised to above 25° C., the gas included in the glass does not give rise to extra pressure that would cause the capsule to bulge due to the effect of the heat.

Insofar as wine naturally contains carbon dioxide, generally at a concentration lying in the range 50 milligrams per milliliter (mg/ml) to 1500 mg/ml, it is preferable to desaturate the wine of carbon dioxide prior to filling the glass, and to do this it is preferable to degas the wine prior to packaging, in particular to reduce its dissolved carbon dioxide content to a value of less than 400 mg/ml, and preferably less than 200 mg/ml.

The carbon dioxide dissolved in wine can be expelled by bubbling through gaseous nitrogen, thereby injecting the gaseous nitrogen into the wine.

To obtain low permeability through the capsule, it is preferable to use a stratified material comprising a layer of pure aluminum coated in a layer of polyethylene.

Such a material is preferably selected for the thickness of the metal layer to lie in the range 10 microns (μm) to 100 μm, and the thickness of the plastics film likewise to be situated in said range of values; this makes it easier to cause the capsule to adhere to the rim of the glass under the effect of heating the capsule, which heating must be performed very quickly in order to avoid heating the wine. For this purpose, the metal layer of the capsule is preferably heated by being put into contact with a resistive heater element, or by induction. Raising the temperature of the metal layer causes the temperature of the plastics film to be raised prior to coming into contact with the rim, thus causing it to adhere to the glass. Said temperatures preferably reach a maximum value of not more than about 350° C., and in particular preferably lying in the range 80° C. to 180° C., for a period of a few seconds or tenths of a second only.

In order to improve adhesion, the capsule is pressed against the glass with a bearing force that preferably lies in the range 10 decanewtons (daN) to 250 daN, and in particular in the range 30 daN to 100 daN.

For this purpose, it is also preferable to use materials to constitute the glass receptacle comprising blown glass or blown and turned glass leaving a bead at the rim of width greater than the wall thickness of the glass, thus improving adhesion of the capsule. Alternatively, in certain cases it is possible to use molded glass.

In another aspect, the invention consists in providing a pack comprising wine packaged in a drinking glass, said glass being closed by a heat-sealed capsule that is substantially oxygen proof, the gaseous atmosphere present inside the glass being depleted in oxygen; the pack can be obtained using the above method.

More particularly, said gaseous atmosphere inside the receptacle comprises carbon dioxide and is at a pressure slightly lower than the surrounding ambient atmospheric pressure. In some cases, it is found that, immediately after packaging, the flexible capsule takes up a shape which is slightly dished towards the inside of the receptacle.

Although the invention applies essentially to packaging wine, it can also be used for packaging oxygen-sensitive beverages other than wine in a glass, in particular alcoholic beverages based on vegetable extracts, and also fruit juices.

The use of a capsule that includes a metal layer facilitates handling of the filled and closed glass because the capsule presents good resistance against being pressed in.

In a variant embodiment, the gaseous atmosphere contained in the glass can be depleted of oxygen by establishing a partial vacuum prior to closing the glass by bonding the capsule onto the glass.

In another aspect, the invention consists in providing an installation for packaging wine or a similar beverage in drinking glasses, the installation comprising:

a conveyor for transporting glasses;

a station for filling glasses with the beverage;

a station for closing each glass by heat-sealing a capsule thereon; and

a station for evacuating the glass or for blowing in an inert gas, preferably comprising carbon dioxide and/or a mixture of nitrogen and carbon dioxide;

said stations being disposed along the conveyor.

The inert gas is preferably blown in both before and after said receptacles are filled with said beverage.

Other advantages and characteristics of the invention will be understood from the following description which refers to the accompanying drawings, showing preferred embodiments of the invention without any limiting character.

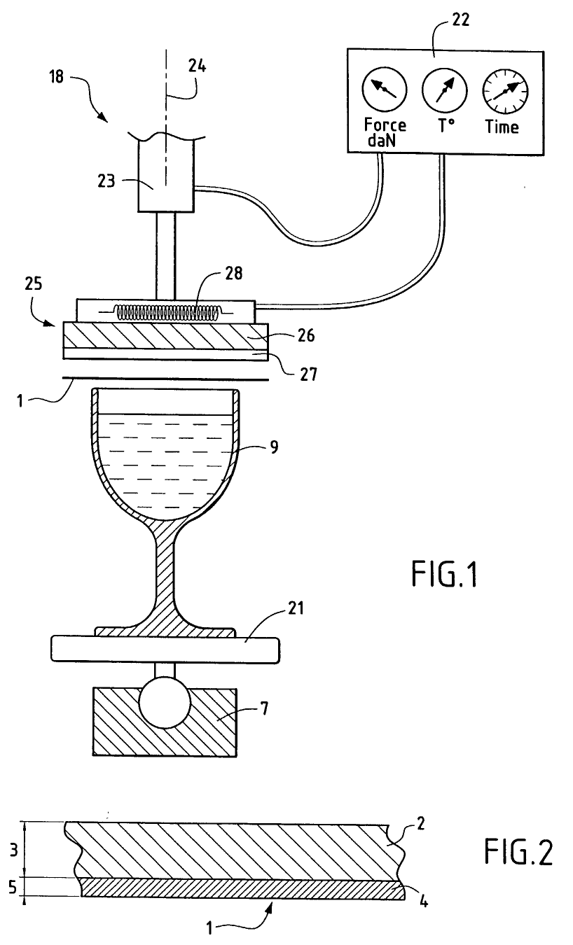

FIG. 1 is a diagram of a station for filling a glass filled with wine.

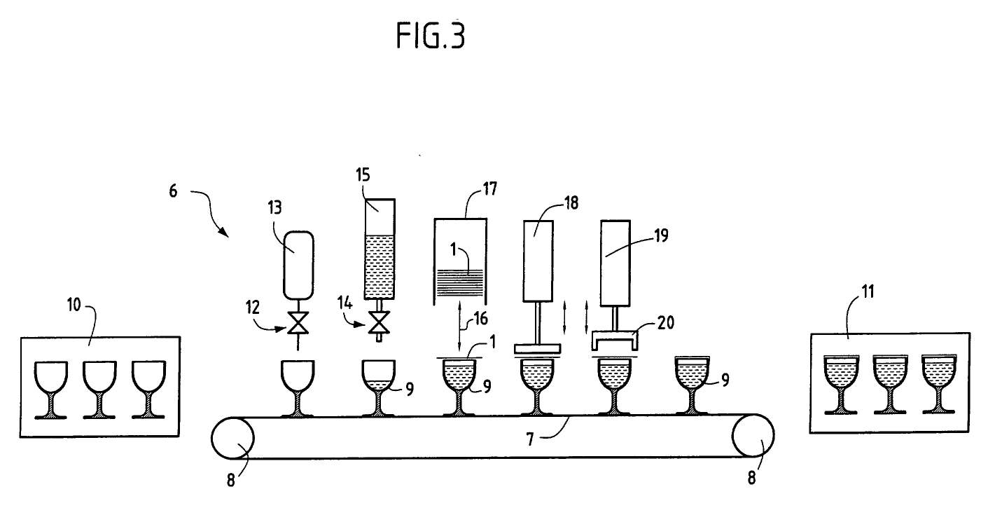

FIG. 2 is a diagrammatic section view of a capsule used in the invention.

FIG. 3 is a diagram showing packaging apparatus of the invention.

With reference to FIG. 2, the stratified material from which the capsule 1 is made comprises a layer 2 of aluminum of thickness 3 lying in the range 30 μm to 50 μm, and carrying a layer 4 of polyethylene which covers the layer 2 and which is of a thickness 5 close to 50 μm.

With reference to FIG. 3, the packaging apparatus 6 comprises a conveyor belt 7 driven over two rollers 8; glasses 9 placed on the top strand of the conveyor belt are conveyed by the belt from a station 10 for storing empty glasses to a station 11 for storing full glasses.

During this transfer, each glass passes successively through five packaging stations or devices:

a station 12 for filling the glass with an inert gas, preferably carbon dioxide or a mixture of carbon dioxide and gaseous nitrogen coming from a tank 13;

a station 14 for filling the glass with wine taken from a container 15;

a station for depositing a capsule 1 on the full glass 9; this being performed by using a suction cup handler (represented diagrammatically by arrow 16) which extracts capsules one by one from a magazine 17;

a station 18 for heat-sealing the capsule 1 on the rim of the glass 9; and

a station 19 for shaping the margin of the capsule so as to fold it down against the walls of the glass; for this purpose, this station comprises an actuator that moves a tool 20 of shape that matches the shape of the rim of the glass.

In a preferred variant embodiment (not shown) the station 12 for blowing in inert gas, preferably carbon dioxide and/or nitrogen (and/or a station for establishing a reduced pressure) is disposed in the vicinity of the capsule sealing station 18 so as to establish a reduced oxygen content immediately before (or during) heat-sealing. In addition, prior to being filled with wine, the glass is preferably placed in a inert atmosphere, in particular of carbon dioxide and/or nitrogen so as to limit oxidation of the wind during the operation of filling the glass.

With reference to FIG. 1, the glass 9 stands on the conveyor 7 via a tray 21 whose top face is adapted to accommodate any lack of planeness in the foot of the glass (e.g. by being made of a material that is compressible).

The apparatus includes a control unit 22 for adjusting the parameters used for heat-sealing the capsule 1. The apparatus also includes an actuator 23 suitable for moving a tool 25 vertically along an axis 24, the tool comprising a solid piece of metal 26. The bottom face of the tool is covered in a deformable pad 27 made of a material that conducts heat, such as silicone. The pad 27 is also provided on its top face with a resistive heater element 28. The power fed to this element, the length of time contact is made with the capsule, and the bearing force applied by the actuator are under the control of the unit 22.

1/ A method of packaging wine or a similar beverage in a receptacle in the form of a drinking glass (9), in which said receptacle is made of glass and said glass receptacle is closed by a disposable capsule (1) having very low overall permeability to oxygen after being closed onto said receptacle.

2/ A method according to claim 1, in which a capsule (1) is selected comprising a metal layer (2) coated in a layer (4) of heat-sealable thermoplastic material, and having overall permeability to oxygen after heat-sealing of not more than 10 cm³/m²/24 h.

3/ A method according to claim 1 or claim 2, in which the oxygen content of the gaseous atmosphere imprisoned within the glass is reduced, with the oxygen content preferably being less than 5%.

4/ A method according to claim 2 or claim 3, in which the glass is filled with wine under an inert atmosphere comprising carbon dioxide.

5/ A method according to any one of claims 1 to 4, characterized in that the dissolved carbon dioxide content of the wine is reduced prior to packaging to a value of less than 400 mg/ml, and preferably of less than 200 mg/ml.

6/ A method according to any one of claims 1 to 5, in which a capsule is selected whose overall permeability to oxygen after being closed onto said receptacle is less than 5 cm³/m²/24 h, and in which the wine is packaged under an inert atmosphere comprising carbon dioxide.

7/ A method according to any one of claims 1 to 6, in which the capsule is made using a stratified material comprising a layer of pure aluminum coated in a layer of polyethylene.

8/ A method according to any one of claims 1 to 7, in which the thickness of the metal layer lies in the range 10 μm to 100 μm, and in which the thickness of the plastics film likewise lies in said range of values.

9/ A method according to any one of claims 1 to 8, in which the capsule is heated to a maximum temperature lying in the range 80° C. to 180° C. for a few seconds or a few tenths of a second.

10/ A method according to any one of claims 1 to 9, in which the capsule is pressed against the glass with a bearing force lying in the range 10 daN to 250 daN, and preferably in the range 30 daN to 100 daN.

11/ A pack suitable for being obtained by a method according to any one of claims 1 to 10, containing a wine or similar beverage packaged in a receptacle in the form of a drinking glass, said receptacle being made of glass and being closed by a heat-sealed capsule (1) that is substantially proof against oxygen, the gaseous atmosphere present inside the glass being depleted in oxygen.

12/ A pack according to claim 11, characterized in that said gaseous atmosphere inside the receptacle comprises carbon dioxide and is at a pressure that is slightly lower than the pressure of the surrounding ambient atmosphere.

13/ An installation for packaging wine or a similar beverage in drinking glasses (9), the installation being characterized in that it comprises:
a conveyor (7) for transporting glasses;
a station (14) for filling glasses with the beverage;
a station (18) for closing each glass by heat-sealing a capsule (1) thereon; and
a station (12) for evacuating the atmosphere imprisoned in the glass or for blowing an inert gas preferably comprising carbon dioxide and/or nitrogen into the glass;
said stations being disposed along the conveyor.

14/ An installation according to claim 13, in which inert gas is blown in both before and after said receptacle is filled with said beverage.
